(19) United States
(12) Patent Application Publication
(10) Pub. No.: US 2006/0037374 A1
(43) Pub. Date: Feb. 23, 2006

(54) Combination mechanism

(76) Inventor: Zachary L. Skelly, Ogdensburg, NY (US)

Correspondence Address: ZACHARY L. SKELLY, P.O. BOX 233, OGDENSBURG, NY, 13669, US

(21) Appl. No.: 10/921,501

(22) Filed: Aug. 19, 2004

(51) Int. Cl. E05B 37/02

(52) U.S. Cl. 70/304

(57) ABSTRACT

A combination device that, when operated through a dial through a pre-determined combination, rotates internal Barriers and aligns a system of holes that allow an optical emitter to extend a beam of light to an optical receptor which sends a signal to a locking mechanism to disengage its lock. Also, by rotating the dial outside of the pre-determined combination, the Barriers' holes are out of alignment and thusly no signal may be sent, which sends a signal to a locking mechanism to engage its lock.

### CROSS-REFERENCE TO RELATED APPLICATIONS

Patent No.: U.S. Pat. No. 6,434,981, Aug. 20, 2002, Fantl, et al.

### STATEMENT REGARDING FEDERALLY SPONSORED RESEARCH DEVELOPMENT

Not applicable

### REFERENCE TO SEQUENCE LISTING, A TABLE, OR A COMPUTER LISTING COMPACT DISK APPENDIX

Not applicable

### BACKGROUND OF INVENTION

This invention pertains to the field of security locking devices. The problem with locking devices WAS that no matter how big or expensive they were, someone, somewhere, could figure out a way to uncover the combination, code, key print, or whatever means was necessary in order to unlock the device without permission.

Security locking mechanisms are used to house most of our most precious objects. These objects could be priceless works of art, jewelry, or secrets even. The list goes on. Everything has value to someone, and whoever holds that value wishes to keep it from those who would otherwise take it from them. As I will attempt to explain and prove, this device does not allow a user to uncover the combination, and thusly defeats any attempt by which a thief, or other un-authorized person trying to gain access through the device, would try and uncover the said combination that would unlock the device.

By having a device that does not allow access to unwanted people, our most precious possessions, whatever they may be, are offered that much more security. This would add peace of mind to all of our lives. Be it simply in knowing that our banks were not going to be robbed, or even that our national secrets were not subject to curious and prying eyes.

As attempted in U.S. Pat. No. 6,434,981, efforts have been made to try and increase the security of locking devices and mechanisms. However, though also utilizing a system of ‘holes’ as this patent does, that patent still relies on a mechanical action to unlock the device. This mechanical action can be detected by some means, simply because action can be sensed by sensory devices. My invention, however, does not have a mechanical action associated with the implementation of the combination, and thusly cannot be detected by such means.

My invention also provides its own safeguards that prevent any method of ‘sensing’ the combination. By not having a mechanically operated combination input, as well as providing safeguards against any possible vulnerability, you prevent any unauthorized entry of the locking device. This creates the most secure locking device to date, as there literally is no known method, or even conceived method, by which this could be bypassed.

### BRIEF SUMMARY OF THE INVENTION

My invention utilizes a system of holes, aligned by a user operating an input dial, which allows a beam of light to pass through those holes and only through those holes, and is then received by some optical sensor on the other side of holes. When the combination is entered properly, the holes are aligned, the light is allowed to pass through and is sensed, and the optical sensor transmits a signal to the lock to disengage. When the beam of light is broken, the sensor sends a signal to engage the lock.

### BRIEF DESCRIPTION OF THE SEVERAL VIEWS OF THE DRAWING

FIG. 1 is a side view of the different Barriers, their components, the Separators, as well as a view of the assembled Barriers and Separators.

FIG. 2 is a front view of the three Barriers.

FIG. 3 is a rear view of the Three Barriers and their components.

FIG. 4 is a front and rear view of the Separators.

FIG. 5 is a slanted view of a Barrier and its pre-drilled hole.

FIG. 6 is a rear view of the Case.

FIG. 7 is a side view the Case.

FIG. 8 is a front view of the Case.

FIG. 9 is an interior view of the assembled device with relation to the Barriers, optical emitter and optical receptor.

### DETAILED DESCRIPTION OF THE INVENTION

My invention appears very similar to conventional combination devices in use on safes today. It is operated in the same manner as well. However, it does not function in a similar manner at all. FIG. 9 shows a diagram of the inside of the device.

Unlike a conventional combination device, there is no mechanical action for ‘unlocking’ the combination. This prevents any means of detection by sensitivity, one of the popular methods of ‘cracking’ combination device codes. The code is entered by turning the dial which in turn turns the various Barriers.

The lack of mechanical action that I mentioned is due to the fact that the turning of the dials themselves does not physically change anything inside the device. The combination is already ‘entered’ by having the holes on the Barriers, that allow the light to pass through from the emitter to the receptor, pre-drilled. By using a passive means of transmission, such as light, as opposed to an active means of transmission, such as a slide bar or ‘cams’, there is no outside detectable difference in Barrier position whether the combination is properly entered or not. Thusly, without actually looking inside the device, there is absolutely no way to bypass entering the combination to unlock the device.

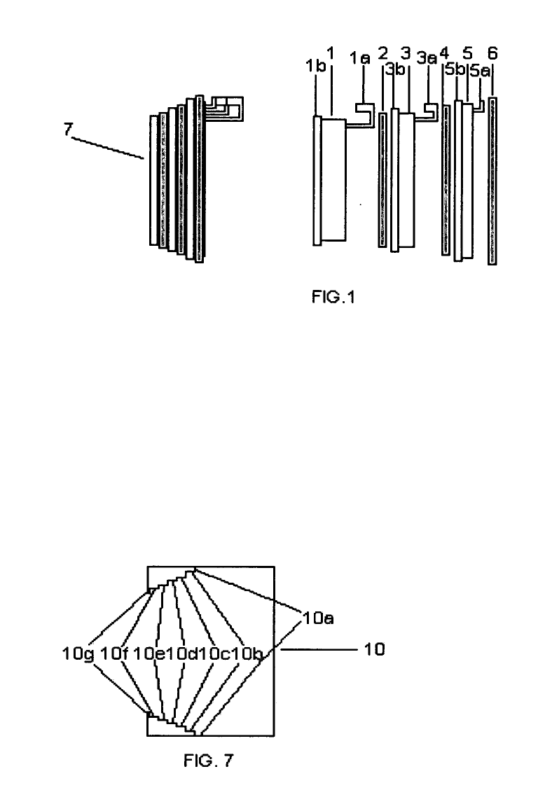

FIG. 1 shows a side view of the Third Barrier. The reason that this is called the “Third Barrier” is because of the fact that it is the last Barrier to be set. The other two Barriers will already be in position when this Barrier is set to its proper position. The Third Barrier must be of a size such that its Lip (1b) and deep, hollowed out ring (1) are small enough to fit completely inside the Second Barrier (3), as well as its Lip (1b) having the perimeter of its outer circumference fitting inside the place setting (10f) made for it on the interior of the Case (10). It must be deep enough so that it will protrude out from the Second Barrier (3) enough space to fit the Third Separator (2) between the Lips of the Third and Second Barriers (7). This Barrier consists of a deep, hollowed out ring (1), a Lip (1b), and a Catch Bar (1a). The deep, hollowed out ring (1) allows the light emitter to be placed inside its hollowed out center. The necessity for this is so that the barriers will prevent the light from reaching the receptor unless the holes are in position, which is only brought about by properly entering the combination code. From the front the Third Barrier (1) is smooth, but from the rear you can see the gap created between the extended Lip (1b) and the deep, hollowed out ring (1), as well as the rear view of the Catch Bar (1a). The Lip (1b) is present so that it fits in between the place setting provided in the Case and the Third Separator (2). This keeps it in its position, free from moving about which would un-align the Barrier, but still allows it to be turned on an axis via the dial. The Catch Bar (1a) is used so that when the dial connected to the Third Barrier is turned, the Catch Bar rotates and ‘catches’ the Catch Bar of the Second Barrier, which when turned one way will ‘catch’ the Catch Bar of the First Barrier to place the First Barrier into position, and when turned the other way will simply place the Second Barrier into its code position.

FIG. 1 shows the Second Barrier. The reason that this is called the “Second Barrier” is because of the fact that it is the second Barrier to be set. The Second Barrier must be of a size such that its Lip (3b) and deep, hollowed out ring (3) are small enough to fit completely inside the First Barrier (5), as well as its Lip (3b) having the perimeter of its outer circumference fitting inside the place setting (10d) made for it on the interior of the Case (10). It must be deep enough so that it will protrude out from the First Barrier (5) enough space to fit the Second Separator (4) between the Lips of the Second and First Barriers (7). This Barrier consists of a deep, hollowed out ring (3), a Lip (3b), and a Catch Bar (3a). The deep, hollowed out ring (3) allows the First Barrier (5) to be placed inside it. The necessity for this is so that the Barrier is in alignment with the other Barriers in preventing the light from reaching the receptor unless its hole is properly aligned with the other Barriers' holes, which only happens when the combination code is properly entered. From the front the Second Barrier (3) is smooth, but from the rear you can see the gap created between the extended Lip (3b) and the deep, hollowed out ring (3), as well as the rear view of the Catch Bar (3a). The Lip (3b) is present so that it fits in between the place setting provided in the Case (10) and the Second Separator (4). This keeps it in its position, free from moving about which would un-align the Barrier, but still allows it to be turned on an axis via the dial through the Third Barrier Catch Bar (1a).

FIG. 1 shows the First Barrier. The reason that this is called the “First Barrier” is because of the fact that it is the first Barrier to be set The First Barrier must be of a size such that its Lip (5b) and deep, hollowed out ring (5c) are small enough to fit completely inside the Case (10), as well as its Lip (5b) having the perimeter of its outer circumference fitting inside the place setting (10b) made for it on the interior of the Case (10). It must be deep enough so that it will not protrude out from the Second Barrier (3) and conform to the size conditions set forth for the Second Barrier (3). This Barrier consists of a deep, hollowed out ring (5), a Lip (5b), and a Catch Bar (5a). The deep, hollowed out ring (5) allows the Second Barrier to be placed inside it. The necessity for this is so that the Barrier is in alignment with the other Barriers in preventing the light from reaching the receptor unless its hole is properly aligned with the other Barriers' holes, which only happens when the combination code is properly entered. From the front the First Barrier (5) is smooth, but from the rear you can see the gap created between the extended Lip (5b) and the deep, hollowed out ring (5), as well as the rear view of the Catch Bar (5a). The Lip (5b) is present so that it fits in between the place setting provided in the Case and the First Separator (6). This keeps it in its position, free from moving about which would un-align the Barrier, but still allows it to be turned on an axis via the dial through the Third Barrier Catch Bar and Second Barrier Catch Bar.

On each of the Barriers a hole must be drilled (9). This hole must correspond to the desired position of that Barrier's combination code number. The Barrier's combination code number is the number that the dial is at, after being turned, when the hole for that Barrier is in alignment with the optical emitter (11) and receptor (12). This is how the combination is programmed into the device. The dial may use any numbering system desired by the manufacturer, the only consideration to be made is that the numbering system outside must be completely aligned with the position of that Barrier's combination code number.

FIG. 1 shows a side view of the Third Separator. This Separator is placed in between the Third Barrier (1) and the Second Barrier (3). The Third Separator (2) must be of a size such that it fits over the deep, hollowed out ring of the Third Barrier (1), and that its screw holes (2a) are completely above the Third Barrier Lip (1b), and that the screw holes (2a) align with the screw holes in the Case (10i). It must be deep enough so that it fits inside the place setting for it on the interior of the Case (10e). It must also be thin enough so that it does not protrude past the holes on the Barriers, which would prevent the light from passing through to the receptor.

FIG. 1 shows a side view of the Second Separator. This Separator is placed between the Second Barrier (3) and the First Barrier (5). The Second Separator (4) must be of a size such that it fits over the deep, hollowed out ring of the Second Barrier (3), and that its screw holes (4a) are completely above the Second Barrier Lip (3b), and that the screw holes (4a) align with the screw holes in the Case (10h). It must be deep enough so that it fits inside the place setting for it on the interior of the Case (10c). It must also be thin enough so that it does not protrude past the holes on the Barriers, which would prevent the light from passing through to the receptor.

FIG. 1 shows a side view of the First Separator. This Separator is placed behind the First Barrier (5) and holds it in place. The First Separator (6) must be of a size such that it fits over the deep, hollowed out ring of the First Barrier (5), and that its screw holes (6a) are completely above the First Barrier Lip (5b), and that the screw holes (6a) align with the screw holes in the Case (10g). It must be deep enough so that it fits inside the place setting for it on the interior of the Case (10a). It must also be thin enough so that it does not protrude past the holes on the Barriers, which would prevent the light from passing through to the receptor.

All of the Barriers and Separators when properly arranged will have a side profile of that seen in 7.

FIG. 5 shows a slanted view of a Barrier. This is to depict how the hole (9) will look on each Barrier (8).

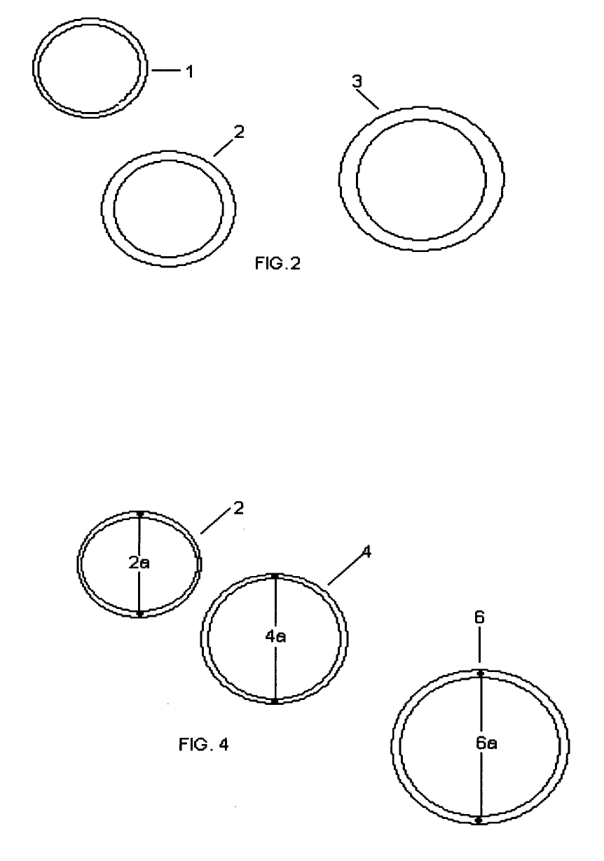

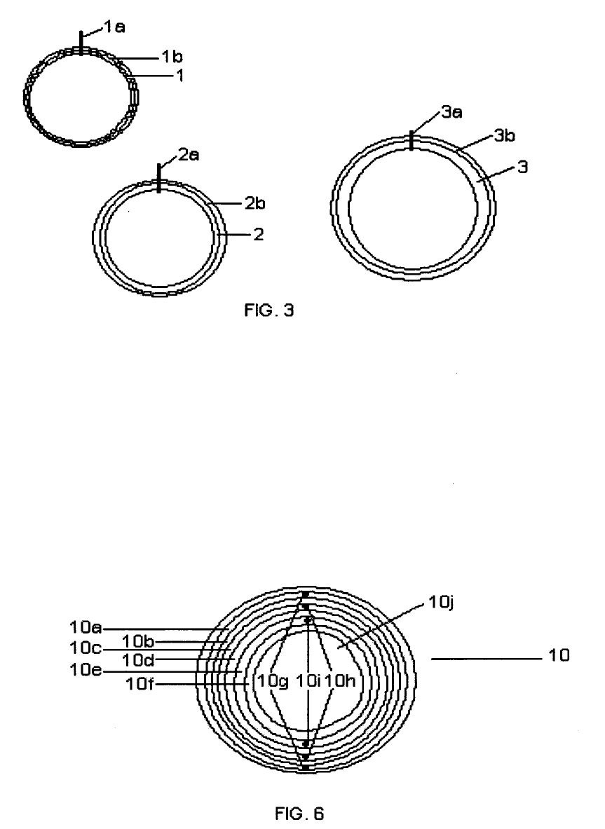

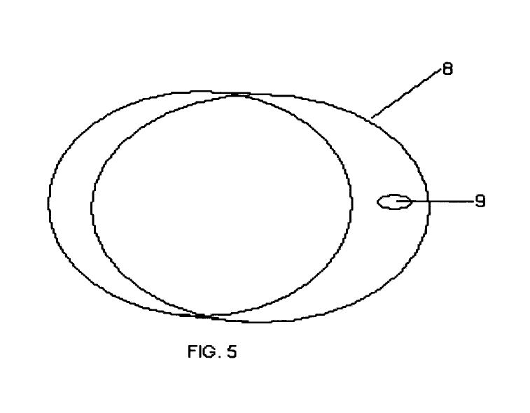

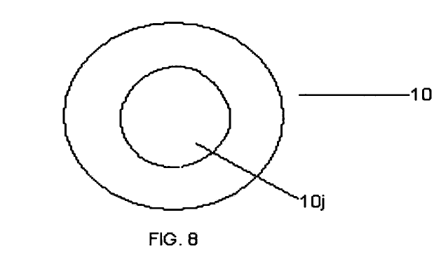

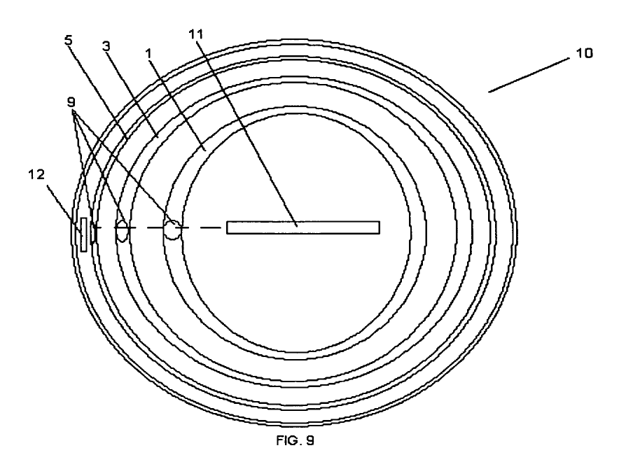

FIG. 7 shows a side view of the interior of the Case. All of the components of the device will be placed inside the Case (10), as previously mentioned with each individual component. The interior of the Case (10) depicts each of the placement positions, previously mentioned, for each of the components. The outside front of the Case (10) can either be flat and level, as depicted, or it may have a ‘ribbed’ effect that would completely correspond with each of the interior layered placement positions (10). The opening (10j) must be of a size so that the Third Barrier (1) will be held in position, and also allow a dial to be mounted on the Third Barrier (1) and protrude out of the opening (10j).

The materials used to make the components of the device may be of any solid, sturdy material. The only other consideration to be made would be lining the entire interior of the case, as well as the rear of whichever dial that will be attached to the front of the Third Barrier (1), with lead, to prevent any means of seeing inside the device, as well as lining the entire interior of the case, as well as the rear of whichever dial that will be attached to the front of the Third Barrier (1), be lined with Plexiglas (or some other heat-sensory blocking material) so that the light may not be sensed, to prevent any means of deriving the combination by such a method.

To assemble the device, you start with the Case (10). You take the Third Barrier (1) and attach a dial to the front (Lip side) that is centered, covering the opening of the deep, hollowed out ring, but still small enough to fit inside the Case opening (10j). You then take the Third Barrier (1) with the attached dial, and place it in its fitting placement position (10f), so that the dial is protruding from the front of the Case (10j). You then take the Third Separator (2) and place it over the Third Barrier (1), in its fitting placement position (10e), with the screw holes of the Separator (2a) and placement position (10i) in alignment, and screw it into place. This holds the Third Barrier (1) in position, but still allows it to be moved freely by the dial. You then take the Second Barrier (3) and place it in its fitting placement position (10d). You then take the Second Separator (4) and place it over the Second Barrier (3), in its fitting placement position (10c), with the screw holes of the Separator (4a) and the placement position (10h) in alignment, and screw it into place. This holds the Second Barrier (3) in position, but still allows it to be moved freely by the dial through the Third Barrier Catch Bar (1a). You then take the First Barrier (5) and place it in its fitting placement position (10b). You then take the First Separator (6) and place it over the First Barrier (5), in its fitting placement position (10a), with the screw holes of the Separator (6a) and the placement position (10g) in alignment, and screw it into place. This holds the First Barrier (5) in position, but still allows it to be moved freely by the dial through the Second Barrier Catch Bar (3a), by the Third Barrier Catch Bar (1a). Now you mount an optical receptor (11) between the deep, hollowed out ring of the First Barrier (5) and the interior edge of the Case (10k). You then mount an optical emitter (12) inside the Third Barrier (1) and attach it to the First Separator (16), so that it will be aligned with the Barrier Holes (9) and the optical receptor (11). You then wire both the optical emitter (11) and receptor (12) outside of the device so that they may be attached to any manufacturer's desired control and energy system, that will both handle powering the system, turning it on and off, as well as sending a signal to the lock device to engage and disengage. Finally, you mount the device onto either a manufacturer's back plate, or directly to the safe or other desired object, in such a manner that would prevent unwanted access to the device's interior.

To use the device you first turn the dial 3 full rotations to the right. This allows the Third Barrier Catch Bar (1a) to catch both the Second Barrier Catch Bar (3a) and the First Barrier Catch Bar (5a). To enter the first number of the combination code, you rotate the dial to the right until you reach the dial number corresponding to the first number in the combination. This will align the First Barrier's (5) hole with the position of the combination code number (in alignment with the optical emitter (11) and receptor (12)). You then turn the dial one full rotation from present position to the left. This will realign the Third Barrier's Catch Bar (1a) so that it is now on the left side the Second Barrier's Catch Bar (3a). To enter the second number of the combination code, you rotate the dial to the left until you reach the dial number corresponding to the second number in the combination. This will align the Second Barrier's (3) hole with the position of the combination code number (in alignment with the optical emitter (11), optical receptor (12), and the First Barrier's (5) hole). To enter the third number of the combination code, you rotate the dial to the right until you reach the dial number corresponding to the third number in the combination. This will align the Third Barrier's (1) hole with the position of the combination code number (in alignment with the optical emitter (11), optical receptor (12), the First Barrier's (5) hole, and the Second Barrier's (3) hole). Now, you have an image like that of FIG. 9, and this allows the manufacturer's control and energy system send a signal from the optical emitter (11) to the optical receptor (12), which in turn sends a signal to the manufacturer's lock device to disengage, allowing entry to the object that this invention is attached to. Upon completion, you rotate the Dial any desired direction, any desired number of times, so that the holes (9) are no longer in alignment with the optical emitter (11) and optical receptor (12), which breaks the link between the two, and sends a signal to the manufacturer's control and power system to engage the lock device, so that the object that this invention is attached to is now in a locked state.

What is claimed is:

1. A combination device comprising:
a case to hold the device;
a single source of light mounted on the case;
an optical receptor mounted on the case in line with, but separate from, the single source of light;
any number of separated circular, overlapping barriers mounted between the optical receptor and single source of light;
A hole drilled in each barrier of equal size in every barrier in sequence so that light may pass through them from the source of light to the optical receptor;
a number of separators, equal to the number of barriers, which are hollowed out circles of metal that can be placed on top of the barriers and mounted on to the case;
a turn dial mounted off from the inner most overlapped barrier extending through and filling up a hole in the case;
an open space on each barrier that can be aligned with each other barrier's open space;
catch bars, which are tiny pieces of metal that can be attached on to and extend off from the barriers;
a single catch bar mounted anywhere along the bottom side of each barrier of a length so that each catch bar can reach only the next catch bar in succession;
a predetermined mechanical combination code formed from the relationship made between the different catch bars and their placement along each barrier, and;
infinite predetermined mechanical combination codes that can be formed by the changing of position of the catch bars in relation to each barrier's open space and the collective barriers together in succession.
